(19) United States
(12) Patent Application Publication
(10) Pub. No.: US 2026/0087338 A1
(43) Pub. Date: Mar. 26, 2026

(54) SYSTEMS AND METHODS FOR CONVERTING AN ANALOG MACHINE LEARNING OUTPUT SIGNAL INTO A DIGITAL SIGNAL

(71) Applicant: Eva Technology Corp, Boston, MA (US)

(72) Inventors: Kevin Blaine Anderson, Arlington, TX (US); Donald Wood Loomis, III, Coppell, TX (US)

(73) Assignee: Eva Technology Corp, Boston, MA (US)

(21) Appl. No.: 18/892,246

(22) Filed: Sep. 20, 2024

(51) Int. Cl. G06N 3/065

(52) U.S. Cl. CPC G06N 3/065

(57) ABSTRACT

Systems and methods are disclosed for analog-to-digital-converter (ADC) solutions supporting analog AI deep learning systems. These systems can outperform their digital counterparts in speed and energy efficiency since computations are conducted directly in memory and analog processors inherently support parallel operations. ADCs play a crucial role in analog AI deep learning because they serve as the bridge between the analog and digital worlds. An analog AI deep learning system may comprise a DAC, a programming module, row/column switches, a crossbar array and an ADC. The ADC may comprise switches for time interleaving of an analog neural network output signal, received from the row/column switches associated with the crossbar array. The time interleaved signals are separately ported between two capacitive paths, and are subsequently coupled to separate inverters. A frequency signal is generated by a logic gate, which is coupled to a digital filter that generates an n-bit digital word.

### BACKGROUND

### A. Technical Field

The present disclosure relates generally to computer learning systems that convert an output signal from the analog domain to the digital domain. More particularly, embodiments of the present disclosure relate to systems and methods that improve power, latency and size parameters of machine learning processes by performing artificial intelligence calculations within the analog domain and converting the output to a digital signal via an analog-to-digital-converter (ADC).

### B. Background

One skilled in the art will recognize the importance and growth of machine learning applications across a variety of technologies and markets. Deep neural networks have achieved great successes in many domains, such as computer vision, natural language processing, recommender systems, etc. As technologists advance the field of machine learning, the time, energy, size and financial resources required to train increasingly complex neural network models are escalating. A promising new domain in artificial intelligence, known as analog deep learning, offers the potential for significantly faster computation with only a fraction of the energy consumption and size of processing resources needed to implement corresponding processing devices. Analog deep learning refers to the implementation of artificial intelligence systems using analog computing principles instead of digital computing across a plurality of computational nodes within a neural network. Analog computing processes information in a continuous manner, akin to how the human brain processes information, making certain types of calculations more natural and efficient.

Analog-to-Digital Converters (ADCs) serve as the bridge between the analog world and the digital realm, making them indispensable components in analog deep learning systems. ADCs play a pivotal role in converting continuous analog signals into discrete digital values, which can then be processed by a neural network.

Accordingly, what is needed are ADCs that efficiently and accurately convert analog signals into digital representations and enable neural networks to learn from and interact with the real world.

### BRIEF DESCRIPTION OF THE DRA WINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may be not to scale.

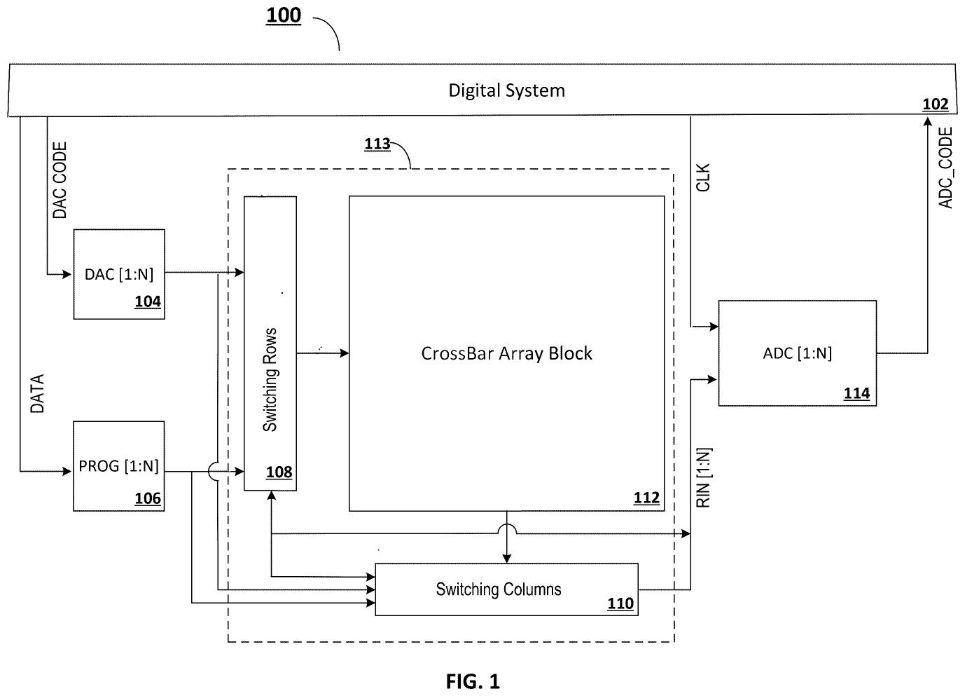

FIG. 1 depicts an analog AI system, according to embodiments of the present disclosure.

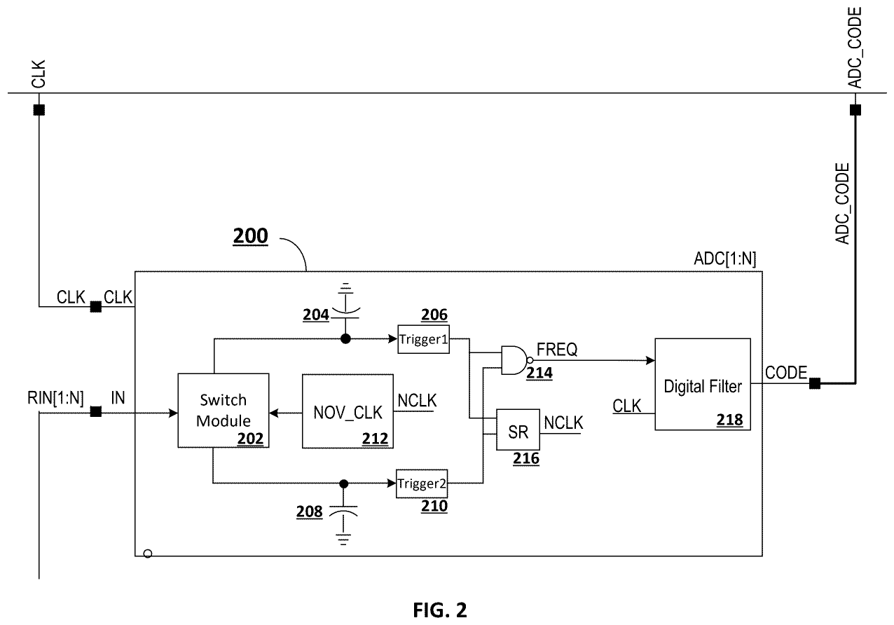

FIG. 2 depicts a crossbar ADC, according to embodiments of the present disclosure.

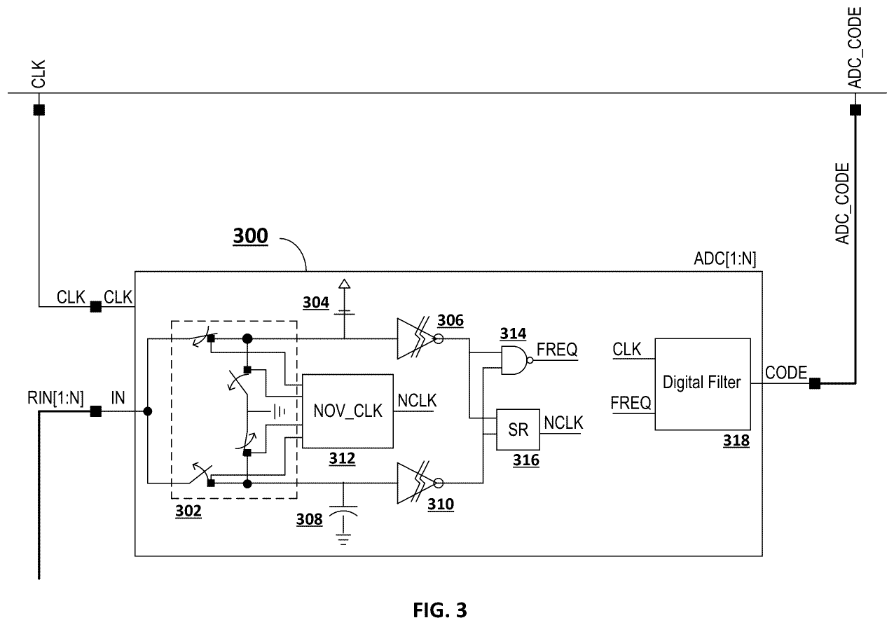

FIG. 3 depicts another embodiment of the crossbar ADC per FIG. 1, according to embodiments of the present disclosure.

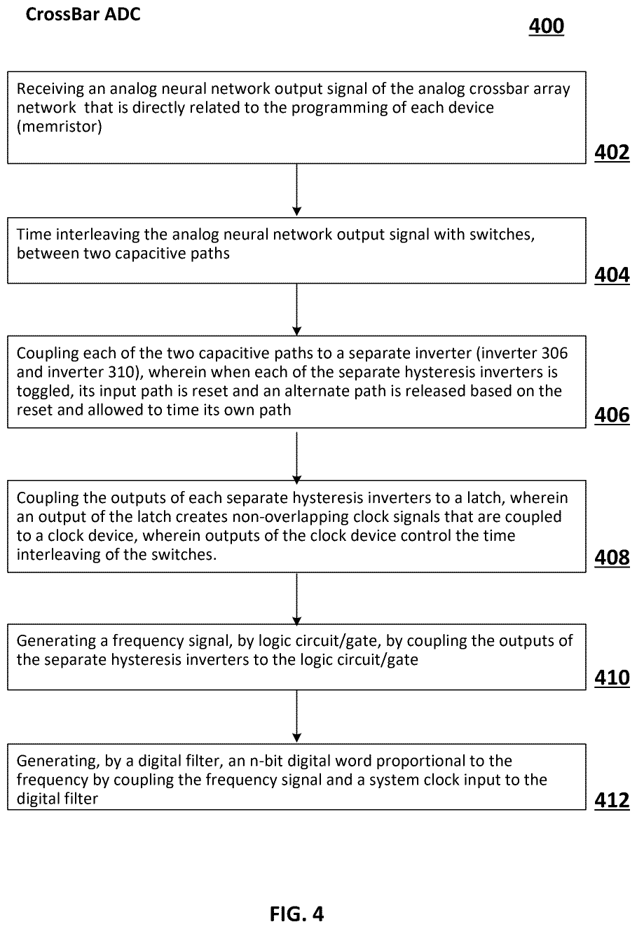

FIG. 4 depicts a flowchart of the operation of the crossbar ADC of FIG. 2 and FIG. 3, according to embodiments of the present disclosure.

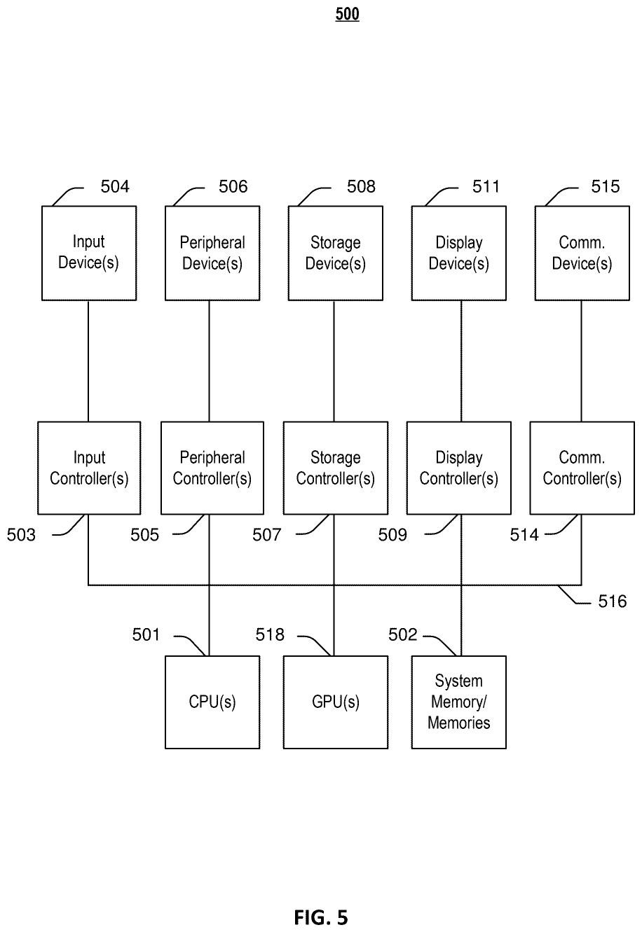

FIG. 5 depicts a simplified block diagram of a computing device/information handling system, according to embodiments of the present disclosure

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” and “comprising” shall be understood to be open terms and any lists the follow are examples and not meant to be limited to the listed items. A “layer” may comprise one or more operations. The use of memory, database, information base, data store, tables, hardware, cache, and the like may be used herein to refer to system component or components into which information may be entered or otherwise recorded. A set may contain any number of elements, including the empty set.

In one or more embodiments, a stop condition may include: (1) a set number of iterations have been performed; (2) an amount of processing time has been reached; (3) convergence (e.g., the difference between consecutive iterations is less than a threshold value); (4) divergence (e.g., the performance deteriorates); (5) an acceptable outcome has been reached; and (6) all of the data has been processed.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document. “Neural network” includes any neural network known in the art.

A service, function, or resource is not limited to a single service, function, or resource; usage of these terms may refer to a grouping of related services, functions, or resources, which may be distributed or aggregated. The use of memory, database, information base, data store, tables, hardware, and the like may be used herein to refer to system component or components into which information may be entered or otherwise recorded. The terms “data,” “information,” along with similar terms may be replaced by other terminologies referring to a group of bits, and may be used interchangeably. Any headings used herein are for organizational purposes only and shall not be used to limit the scope of the description or the claims. All documents cited herein are incorporated by reference herein in their entirety.

It shall also be noted that although embodiments described herein may be within the context of deep learning, aspects of the present disclosure are not so limited. Accordingly, aspects of the present disclosure may be applied or adapted for use in other contexts

### Analog AI Deep Learning and Analog to Digital Converters (ADC)

Solutions for analog AI deep learning may include a crossbar array and a crossbar ADC, according to various embodiments of the invention. At the heart of crossbar arrays for analog deep learning are programmable resistors, which serve a similar foundational role to transistors in digital processors. By arranging arrays of programmable resistors in intricate layers, researchers can construct networks of analog artificial “neurons” and “synapses” that perform computations akin to those in a digital neural network. These networks can be trained to execute sophisticated AI tasks such as image recognition and natural language processing. The use of programmable resistors dramatically accelerates the training process of neural networks while substantially lowering the associated costs and energy consumption. As used herein, “analog AI deep learning” may be considered equivalent to “analog deep learning”.

Analog deep learning can outperform its digital counterpart in terms of speed and energy efficiency by orders of magnitude for at least two reasons. First, computation is conducted directly in memory, eliminating the need to transfer vast amounts of data back and forth between memory and a processor. Second, analog processors inherently support parallel operations. As the matrix size increases, an analog processor can handle the additional computations without requiring more time, since all operations occur simultaneously. This technology is particularly useful in applications where processing time and low power consumption are crucial, such as in training large language models (LLMs).

A high-performance analog to digital converter (ADC) can play a critical role in the overall system performance for analog deep learning by efficiently converting continuous analog signals from an analog crossbar array to discrete digital signals, which then can be processed by the digital portions of a neural network circuit.

FIG. 1 depicts an analog AI system 100, according to embodiments of the present disclosure. As used herein, “analog AI system 100”, may be referred to as system 100. System 100 can be utilized to implement an analog AI deep learning system. System 100 may be considered a deep learning training accelerator. System 100 may comprise digital system 102, digital-to-analog converters DAC [1:N] 104, programming module PROG [1:N] 106, switching rows 108, switching columns 110, crossbar array block 112 and an analog converter, ADC [1:N] 114. ADC [1:N] 114 may be referred to as ADC 114. Crossbar array block 112 may be considered as a portion of a neural network operating in the analog domain and may have a N×M structure. In other embodiments, the crossbar array block 112 may be in a N×N structure. Analog crossbar array network 113 may comprise switching rows 108, switching columns 110 and crossbar array block 112. As used herein, “ADC [1:N] 114” may be referred to as “ADC 114”

Digital system 102 comprises digital signals that may be parallel processed by analog crossbar array network 113. Specifically, DAC 104 may receive digital inputs, such as a DAC CODE, from digital system 102. The programming module 106 (e.g., PROG [1:N] 106) may provide settings for incrementally (positively or negatively) controlling the weight values for programmable components within crossbar array block 112. The programmable components maybe be referred to as programmable resistors or memristors. Switching rows 108 and switching columns 110 may comprise switches that control the parallel processing conducted by crossbar array block 112. As previously noted in FIG. 1, the combination of switching rows 108, switching columns 110 and crossbar array block 112 may be referred to as analog crossbar array network 113. ADC 114 may receive an ADC input (e.g., RIN [1:N]), which may be an analog current signal generated from collective outputs of switching rows 108 and switching columns 110 that are generated by crossbar array block 112. ADC 114 may also receive a clock signal, CLK, and generate a digital output, such as an ADC_CODE, which is coupled to digital system 102. The ADC input (e.g., RIN [1:N]) is generated based on a parallel impedance of the nodes of rows and columns within crossbar array block 112. Note that the rows and columns of nodes in the crossbar array block 112 are different than rows and columns in switching rows 108 and switching columns 110. The elements DAC 104 and ADC 114 may have values of [1:N] as indicated in FIG. 1. Programming module 106 is referenced on FIG. 1 as PROG [1:N] 106. ADC input (e.g., RIN [1:N]) may be considered an analog machine learning output signal.

In the following paragraphs, these subjects will be discussed: core element, matrix multiplication, memristors, programming module, forward/backward/updating phases, and control lines.

Systems 100 may be utilized to implement a chip for an AI training accelerator. Core elements may include: semiconductor level blocks, which include proton gate transistors, an analog block with cross point array and ADC, and a digital block.

Crossbar arrays implemented in analog AI offer significant benefits compared with digital solutions. With basic matrix multiplication, one selects inputs, and then multiplies the inputs together, and repeats the operations and multiplication many times and then adds the results. With methods implemented with an analog AI system, e.g., systems 100, the system converts the inputs into analog voltages. An analog voltage is applied across the crossbar array, after which a multiplication vector is applied by an array using cross point elements, allowing in a single operation a full vector matrix multiplication result. The method can be extremely fast compared with basic matrix multiplication utilizing digital computer processing. Importantly, the method does not require fetching weights from a memory, as the weights were calculated and applied in real-time. Because the method is analog, a corresponding current is created at each node based on the applied voltage which allows these currents to be summed within the crossbar array block 112.

In certain embodiments, the summation of currents occurs at the bottom of the crossbar array block 112. The result is a sum of products for each one of these columns. The results are simultaneous, and none of the weights were moved from a memory into an ALU, and then executed like a multiplication using a digital multiplier, as may occur with a digital computer system. With a digital computer system, at the very least, this process may require movement of 200 transistors. And by some other estimates, there may be between 200 and 300 transistors that may be replaced by these cross-point elements. Accordingly, a solution with analog crossbar arrays can be extremely efficient from an energy perspective, and from a throughput perspective as analog crossbar arrays are significantly faster than their digital counterparts.

Relative to system 100, the output from the analog crossbar array network 113 (e.g., RIN [1:N]) is an analog current signal that is an input to ADC [1:N] 114, which measures the value of the analog signal and converts it to a digital value. Effectively, RIN [1:N] represents the value of the matrix multiplication from the crossbar array block 112. Nodes within the crossbar array block 112 are processed and updated using three processes performed in parallel: namely a forward pass, a backwards pass and an update procedure. For the forward pass, inputs are fed into rows and corresponding outputs are received from columns. For the backward pass, the input ports and output ports are swapped, where inputs are fed into columns and corresponding outputs are received from rows. An update pass is performed on one or more nodes in which the set of weight values is updated on the node based on errors backpropagated during the training process.

Analog weight values are maintained and updated on each node using memristors. A memristor is a circuit device that defines the relationship between magnetic flux and electric charge. It functions similarly to a resistor but with a key difference: its resistance varies based on the charge that flows through it. This property allows the memristor to remember the amount of charge, effectively giving it memory capabilities, e.g. for representing network parameters, i.e., weights. The development of nano-memristive devices may enable non-volatile random-access memory, offering advantages in integration, power consumption, and read/write speeds compared to traditional random-access memory. Memristors can be particularly well-suited for implementing artificial neural network synapses in hardware, making them a promising technology for advanced computing applications.

In system 100, a digital input (e.g., DAC CODE) may be converted to an analog input for submission to crossbar array block 112 via switching rows 108 and/or switching columns 110. At each of the nodes in crossbar array block 112, there are weights stored by a cross-point element, e.g., a memristor device. A memristor device may be considered a cross between a transistor and a resistor with the ability to store weights in an analog node such that a memristor is a programmable resistor, where the conductance value can be fine-tuned in an incremental fashion and represents the weight itself. Therefore, when a voltage is applied, the voltage is multiplied with conductance, and the input gets multiplied with a weight value.

Thus, one may adjust weights across the crossbar array block 112 by effectively tuning resistance on a particular node to change the weight value. One skilled in the art will recognize that a device conductance can be updated in a fully parallel manner inside that array, rather than updating column by column, or row by row, when selecting the molecule. The output of the rows and columns of the crossbar array block 112 is an analog neural network output signal. The analog neural network output signal may also be referred to as a parallel impedance signal.

A separate programming module can provide programming to train and generate weight values. In response to identifying the weight values, a control signal may be generated to set the resistance on that node. The weight is realized in an analog form across that node. As previously noted, the programming module 106 generates control lines that are respectively coupled to switching rows 108, and switching columns 110, which allow weight values on specific nodes to be individually addressed and managed.

As previously discussed, the operation of an analog crossbar array network 113 of system 100 may have three phases: forward/backward/update in accordance with various embodiments of the invention. A first transmission through the analog crossbar array network 113 may be considered a forward path that is used for forward pass training. After a training process reaches an end of the network, an error signal with respect to the loss function may be generated that is used to update the network. If there is a loss function, then the loss function may be used to compute one or more gradients using a backward pass to identify errors and update and improve accuracy of the neural network. In certain embodiments, DAC switches within columns may be used to drive a backwards training pass.

FIG. 1 comprises a programming module that is responsible for weight updates. In this example, the is programming module is illustrated as PROG [1:N] 106. Weights may be updated based on the three operation phases: forward, backward and update.

For example, training may occur using the forward path to perform calculations at nodes, a corresponding backward path may be used to identify one or more errors associated with the calculations and updates of weights at the nodes within crossbar array block 112 are provided to improve the accuracy of the subsequent calculations at one or more of the nodes within crossbar array block 112. This process is repeated until the neural network is satisfactorily trained. In certain embodiments, once an accuracy target is reached, the weights are read through another algorithm such that conductance values are extracted and subsequently converted to digital values. These digital values may be identified as weights that can be stored in regular matrices on an inference processor, or as starting values for subsequent training.

As previously noted, programming module 106 provides control lines that are coupled to switching rows 108 and switching columns 110.

Control lines are coupled into each one of those nodes, effectively instructing in defining weight values on each of the nodes on an increment or decrement basis. Considering the crossbar array as a whole, if a neural network training group is implemented, then the first phase can be a forward pass, and then a backward pass, then a multiply accumulate (i.e., update).

In certain embodiments, the outputs of the switches of switching rows 108 and switching columns 110 are coupled to the matrix of memristors of crossbar array block 112. Connectivity between crosspoint nodes, including the lines that go to the gates and the lines that go to the sources, provide dynamic pathways to enable algorithms that basically change each and every crosspoint parameter, such as the weights, by an incremental manner in the update cycle. This process then repeats the sequence again with a new forward, backwards, update cycle.

In summary, various embodiments of an analog-based machine learning system, including an analog crossbar array network 113, which is part of a neural network, operates in the analog domain. Each of these nodes in the analog-based machine learning system is performing mathematical calculations that need to be executed. Inputs are then applied to the weights to realize the calculations, and then the analog crossbar array network 113 couples the output in the analog domain to the analog crossbar array network 113. The result is a digital output, e.g., ADC_CODE of FIG. 1, from the crossbar array processing architecture.

FIG. 2 depicts a crossbar ADC 200 (e.g., ADC [1:N]), according to embodiments of the present disclosure. Crossbar ADC 200 receives inputs (e.g., RIN [1:N]) from crossbar array block 112, wherein the inputs are coupled to switch module 202. A first output of switch module 202 is coupled to a first capacitor 204 and a first trigger 206. A second output of switch module 202 is coupled to a second capacitor 208 and a second trigger 210. In certain embodiments, the outputs of the first trigger 206 and the second trigger 210 are 1) coupled to NAND gate 214, which in turn generates a frequency signal (FREQ), and 2) coupled to latch SR 216, which in turn generates clock NCLK. Clock NCLK is an input to a timing block (e.g., NOV_CLK) 212, which generates an input to switch module 202. Frequency signal (FREQ) is coupled to digital filter 218, which generates a digital signal (e.g., ADC_CODE). Crossbar ADC 200 receives a reference clock, CLK, to time operations therein. Switch module 202 may be referred to as switches 202.

In certain embodiments, crossbar ADC 200 inputs (e.g., RIN [1:N]) may be multiplexed from either a row or column of the crossbar array block 112. In both configurations, there are N devices connected in parallel since in this embodiment the crossbar array block 112 is an N×N array. The parallel impedance of the rows and/or columns of the crossbar array block 112 may be directly related to the programming of each device. This parallel impedance may have a minimum and maximum value. Crossbar ADC 200 measures the value of the parallel impedance to enable the timing of activation of charging paths between the two capacitors. To accomplish this task, as noted above, the outputs of the first trigger 206 and the second trigger 210 are converted to a frequency via NAND gate 214. This frequency is applied to digital filtering circuitry (e.g., digital filter 218) to convert the frequency to an n-bit digital word proportional to the frequency value (e.g., ADC_CODE).

To convert the ADC inputs (e.g., RIN [1:N]) to a frequency, the analog signal is time interleaved, with switch module 202, between two capacitive paths of a first capacitor 204 and a second capacitor 208. A first path is coupled to the first trigger 206 and a second path is coupled to the second trigger 210. In certain embodiments, a trigger device may be a hysteresis inverter wherein each inverter may be coupled to one of the inputs of a latch SR 216. The output of the latch SR 216 is used to create non-overlapping clock signals (e.g., NOV_CLK). The outputs of the NOV_CLK control the time interleaved switches, e.g. switch module 202. Thus, when an inverter is toggled, its input path is reset and the alternate path is released from reset and allowed to time its own path. In certain embodiments, the inverter's outputs are coupled to a two input NAND gate 214, which generates the frequency (FREQ) that is then coupled to the digital filtering (e.g., digital filter 218).

FIG. 3 depicts a crossbar ADC 300 (e.g., ADC [1:N]), according to embodiments of the present disclosure. Crossbar ADC 300 may be considered an embodiment of crossbar ADC 200 shown in FIG. 2. As illustrated in this example, the following blocks of crossbar ADC 200: first capacitor 204, second capacitor 208, NOV_CLK 212, NAND gate 214, latch SR 216 and digital filter 218, may be considered equivalent to the following blocks of crossbar ADC 300: first capacitor 304, second capacitor 308, NOV_CLK 312, NAND gate 314, latch SR 316 and digital filter 318. Crossbar ADC 300 may also include: 1) time interleaved switch module 302; 2) inverter 306 and inverter 310 where inverter 306 and inverter 310 may be hysteresis inverters. Time interleaved switch module 302 may be referred to as switches 302. Switch module 302 may comprise four switches that generate time interleaved analog neural network output signals (i.e., time interleaved parallel impedance signals) that are coupled to the two separate capacitive paths and also provide coupling to a clock device, NOV_CLK.

In a similar manner to FIG. 2, to convert the input analog signal (e.g., RIN [1:N]) to the crossbar ADC 200 to a frequency, the input analog signal is time interleaved, with time interleaved switch module 302, between a first path having a first capacitor 304 and a second path having a second capacitor 308. Each path is coupled to inverter 306 and inverter 310. Each inverter is coupled to one of the inputs of latch SR 316. The output of the latch SR 316 is used to create non-overlapping clock signals (e.g., NOV_CLK 312). The outputs of the NOV_CLK 312 control the time interleaved switch module 302. Thus, when an inverter is toggled, its input path is reset and the alternate path is released from reset and allowed to time its own path. NAND gate 314, with two inputs, is coupled to both inverters' outputs (inverter 306 and inverter 310) and generates the frequency signal (FREQ) that is coupled to the digital filtering (digital filter 318). If one inverter's output is named SZ and the other is named RZ, a typical waveform may appear as follows:

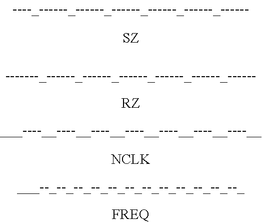

One skilled in the art will recognize that this functional and structural description of an ADC that converts an analog signal from an analog-based neural network into a digital signal represents an embodiment of the invention. Variations to this embodiment, both structurally and functionally may also be implemented in accordance with the invention.

The digital filter 318 inputs may comprise a reference CLK input and the FREQ input. FREQ is also a clock signal and is asynchronous to the reference CLK. The digital filter may be a Cascaded-Integrated-Comb (CIC) filter response but may operate without cascading registers. For a traditional CIC filter with an order of M-th degree, there may exist M cascaded accumulating registers and M cascaded differential registers. The accumulators and the differentiators are separated by a down-sampling clock. Each edge of CLK will accumulate a bit or word into the cascaded integrators. Thus, for a down sampling (D) of 5 and M=2 there may be 10 total clocks for a single conversion with a down-sampling clock happening on the 5th cycle. It can be shown that for each of the i-th CLKs, a weighted gain exists for each input cycle and is independent of all other input cycles. For example, with D=5 and M=2, the weighted gains are W=0 1 2 3 4 5 4 3 2 1. If the input bitstream was BS=0 0 1 0 0 1 0 0 1 0, the sum product output is Code=2+5+2=9.

These gains of weighted sum products WSP may be built in digital circuits, but require a comparable size footprint to their corresponding CIC registers. However, if 100 ADCs are required, a traditional approach would also require 100 CIC filters. But with this aforementioned technique, the 100 ADCs only require 1 accumulator for the WSP math and there needs to exist only a single WSP circuit created with the reference CLK. The single WSP value is multiplexed to the 100 ADCs accumulators.

One skilled in the art will recognize the importance of capacitor sizing within the ADC. Determining a value for each capacitor 204, 208, 304 and 308 has importance in affecting the performance of the present embodiments of analog AI deep learning. The sizing of the referenced capacitors may determine a range and resolution of inner product results for the crossbar array. One skilled in the art will recognize that the size of the capacitors will affect the speed and size of the ADC as well as the performance of the ADC. In many instances, the capacitor sizes may be selected based on the parameters of the analog crossbar array that generates analog inputs into the ADC.

FIG. 4 depicts a flowchart 400 of the operation of the crossbar ADC 200/300 of FIGS. 2 and 3, according to embodiments of the present disclosure. The steps of flowchart 400 are detailed below:

As shown in flowchart 400, the operation begins with crossbar ADC 200/300 receiving an analog neural network output signal of the analog crossbar array network that is directly related to the programming of each device (e.g., memristor), wherein this analog neural network output signal may have minimum and maximum values. (Step 402).

Next, time interleaving the analog neural network output signal with switches (e.g., switch module 202/302), between two separate capacitive paths based on a first capacitor 304 and a second capacitor 308. (Step 404).

Next, coupling each of the two separate capacitive paths to a separate inverter (e.g., inverter 306 and inverter 310), wherein when each of the separate hysteresis inverters is toggled, its input path is reset and an alternate path is released based on the reset and allowed to time its own path. (Step 406)

Next, coupling the outputs of each separate hysteresis inverter to a latch (e.g., latch SR 316), wherein an output of the latch creates non-overlapping clock (NCLK) signals that are coupled to a clock device, NOV_CLK 312, wherein outputs of the clock device, NOV_CLK, control the time interleaving of switch module 302. (Step 408)

Next, generating a frequency signal (FREQ), by NAND gate 314, by coupling the outputs of each hysteresis inverter (306/310) to the NAND gate 314. (Step 410)

Then, generating, by a digital filter 318, an n-bit digital word proportional to the frequency by coupling the frequency signal (FREQ) and a system clock CLK input to the digital filter 318. (Step 412)

Embodiments of a system for an Analog-to-Digital Converter (ADC) may comprise 1) a switch module that receives an analog neural network output signal from an analog crossbar array network and outputs a first time interleaved analog neural network output signal to a first capacitive path and outputs a second time interleaved analog neural network output signal to a second capacitive path; 2) a first capacitor and a second capacitor, which are separately coupled to the first capacitive path and the second capacitive path, respectively; 3) a first trigger that receives the first time interleaved analog neural network output signal and a second trigger that receives the second time interleaved analog neural network output signal; 4) a logic gate that receives the outputs of the first trigger and the second trigger and generates a frequency signal, wherein the logic gate may be a NAND gate; and 5) a digital filter that receives the frequency signal and a system clock and generates an n-bit digital word proportional to the frequency signal. In some embodiments, the analog neural network output signal may be based on programming of a matrix of memristor devices within the analog deep learning crossbar array. In other words, the analog neural network output signal may represent a value of a matrix multiplication from the analog deep learning crossbar array. The first trigger and the second trigger each may comprise a hysteresis inverter. When each of the first trigger and second trigger is toggled, its input path is reset and an alternate path is released based on the reset and allowed to time its own path. In some embodiments, The ADC may comprise a latch that receives the outputs of each of the first trigger and the second trigger, wherein an output of the latch creates a non-overlapping clock (NCLK) signal that is coupled to a clock device, NOV_CLK, wherein outputs of the clock device, NOV_CLK, control the switch module. In some embodiments, the switch module may comprise a first switch and a second switch, which generate the first time interleaved analog neural network output signal and the second time interleaved analog neural network output signal. The switch module may further comprise a third switch and a fourth switch that receive the first time interleaved analog neural network output signal and the second time interleaved analog neural network output signal and are coupled to a clock device, NOV_CLK. The size of the first capacitor and the second capacitor may determine a range and resolution of inner product results for the analog deep learning crossbar array. In some embodiments, the digital filter is a Cascaded-Integrated-Comb (CIC) filter that operates without cascading registers.

### Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

FIG. 5 depicts a simplified block diagram of an information handling system (or computing system), according to embodiments of the present disclosure. It will be understood that the functionalities shown for system 500 may operate to support various embodiments of a computing system, although it shall be understood that a computing system may be differently configured and include different components, including having fewer or more components as depicted in FIG. 5.

As illustrated in FIG. 5, the computing system 500 includes one or more CPUs 501 that provide computing resources and control the computer. CPU 501 may be implemented with a microprocessor or the like, and may also include one or more graphics processing units (GPU) 518 and/or a floating-point coprocessor for mathematical computations. In one or more embodiments, one or more GPUs 518 may be incorporated within the display controller 509, such as part of a graphics card or cards. The system 500 may also include a system memory 502, which may comprise RAM, ROM, or both.

A number of controllers and peripheral devices may also be provided, as shown in FIG. 5. An input controller 503 represents an interface to various input device(s) 504. The computing system 500 may also include a storage controller 507 for interfacing with one or more storage devices 508 each of which includes a storage medium such as magnetic tape or disk, or an optical medium that might be used to record programs of instructions for operating systems, utilities, and applications, which may include embodiments of programs that implement various aspects of the present disclosure. Storage device(s) 508 may also be used to store processed data or data to be processed in accordance with the disclosure. The system 500 may also include a display controller 509 for providing an interface to a display device 511, which may be a cathode ray tube (CRT) display, a thin film transistor (TFT) display, organic light-emitting diode, electroluminescent panel, plasma panel, or any other type of display. The computing system 500 may also include one or more peripheral controllers or interfaces 505 for one or more peripherals 506. Examples of peripherals may include one or more printers, scanners, input devices, output devices, sensors, and the like. A communications controller 514 may interface with one or more communication devices 515, which enables the system 500 to connect to remote devices through any of a variety of networks including the Internet, a cloud resource (e.g., an Ethernet cloud, a Fiber Channel over Ethernet (FCOE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

As those skilled in the art will appreciate, suitable implementation-specific modifications may be made, e.g., to adjust for the dimensions and shapes of the input data. The relatively small and square input data and kernel sizes, their aspect ratios, their orientations, and channel counts have been chosen for convenience of illustration and are not intended as a limitation on the scope of the present disclosure.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.
instructions which, when executed by at least one of the one or more processors, causes steps to be performed comprising:
receiving an analog neural network output signal from an analog crossbar array network, wherein the analog neural network output signal is based on programming of a matrix of memristor devices within the analog crossbar array network;
time interleaving the analog neural network output signal by a switch module between two separate capacitive paths based on a first capacitor and a second capacitor, respectively;
coupling each of the two separate capacitive paths to separate inverters;
generating a frequency signal by coupling outputs of the separate inverters to a logic gate; and
generating, by a digital filter, an n-bit digital word proportional to the frequency signal by coupling the frequency signal and a system clock CLK input to the digital filter.

What is claimed is:

1. A method for operation of an Analog-to-Digital Converter (ADC) comprising:
receiving an analog neural network output signal from an analog crossbar array network;
time interleaving the analog neural network output signal by a switch module between two separate capacitive paths that are based on a first capacitor and a second capacitor, respectively;
coupling each of the two separate capacitive paths to separate inverters;
generating, by a logic gate, a frequency signal by coupling outputs of the separate inverters to the logic gate; and
generating, by a digital filter, an n-bit digital word proportional to the frequency signal by coupling the frequency signal and a system clock CLK input to the digital filter.

2. The method of claim 1 wherein,
the analog neural network output signal represents a parallel impedance of the rows and/or columns and is based on programming of each programmable component within the analog crossbar array network.

3. The method of claim 2 wherein,
the analog neural network output signal has a minimum and maximum value.

4. The method of claim 1 wherein the separate inverters are hysteresis inverters.

5. The method of claim 4 wherein when each of the separate inverters are toggled, its input path is reset and an alternate path is released based on the reset and it is allowed to time its own path.

6. The method of claim 1 further comprising, coupling the outputs of each of the separate inverters to a latch, wherein an output of the latch generates a non-overlapping clock (NCLK) signal that is coupled to a clock device NOV_CLK, wherein outputs of the clock device, NOV_CLK, control the switches.

7. The method of claim 1, wherein the switch module comprises four switches that generate the time interleaved analog neural network output signals that are coupled to the two separate capacitive paths and coupled to a clock device, NOV_CLK.

8. The method of claim 1, wherein the logic gate is a NAND gate.

9. A system for an Analog-to-Digital Converter (ADC) comprising:
a switch module that receives an analog neural network output signal from an analog crossbar array network and outputs a first time interleaved analog neural network output signal to a first capacitive path and outputs a second time interleaved analog neural network output signal to a second capacitive path;
a first capacitor and a second capacitor, which are separately coupled to the first capacitive path and the second capacitive path, respectively;
a first trigger that receives the first time interleaved analog neural network output signal and a second trigger that receives the second time interleaved analog neural network output signal;
a logic gate that receives the outputs of the first trigger and the second trigger and generates a frequency signal; and
a digital filter that receives the frequency signal and a system clock and generates an n-bit digital word proportional to the frequency signal.

10. The system of claim 9 wherein the analog neural network output signal is based on programming of a matrix of memristor devices within the analog crossbar array network.

11. The system of claim 9 wherein the first trigger and the second trigger each comprise a hysteresis inverter.

12. The system of claim 11 wherein when each of the first trigger and second trigger is toggled, its input path is reset and an alternate path is released based on the reset and it is allowed to time its own path.

13. The system of claim 9 further comprising a latch that receives the outputs of each of the first trigger and the second trigger, wherein an output of the latch creates a non-overlapping clock (NCLK) signal that is coupled to a clock device, NOV_CLK, wherein outputs of the clock device, NOV_CLK, control the switch module.

14. The system of claim 9 wherein the logic gate is a NAND gate.

15. The system of claim 9 wherein the switch module comprises a first switch and a second switch, which generate the first time interleaved analog neural network output signal and the second time interleaved analog neural network output signal.

16. The system of claim 15 wherein the switch module further comprises a third switch and a fourth switch that receive the first time interleaved analog neural network output signal and the second time interleaved analog neural network output signal and are coupled to a clock device, NOV_CLK.

17. The system of claim 9, wherein a size of the first capacitor and the second capacitor determines a range and resolution of inner product results for the analog crossbar array network.

18. The system of claim 9, wherein the digital filter is a Cascaded-Integrated-Comb (CIC) filter that operates without cascading registers.

19. The system of claim 9, wherein the analog neural network output signal represents a result of a matrix multiplication from the analog crossbar array network.

20. A system for an Analog-to-Digital Converter (ADC) for an analog deep learning system comprising:
one or more processors; and
a non-transitory computer-readable medium or media comprising one or more sets of instructions which, when executed by at least one of the one or more processors, causes steps to be performed comprising:
receiving an analog neural network output signal from an analog crossbar array network, wherein the analog neural network output signal is based on programming of a matrix of memristor devices within the analog crossbar array network;
time interleaving the analog neural network output signal by a switch module between two separate capacitive paths based on a first capacitor and a second capacitor, respectively;
coupling each of the two separate capacitive paths to separate inverters;
generating a frequency signal by coupling outputs of the separate inverters to a logic gate; and
generating, by a digital filter, an n-bit digital word proportional to the frequency signal by coupling the frequency signal and a system clock CLK input to the digital filter.
